(19) United States
(12) Patent Application Publication
(10) Pub. No.: US 2026/0330472 A1
(43) Pub. Date: Oct. 22, 2026

(54) METAL RECYCLING AND REGENERATION PRODUCTION TRACEABILITY SYSTEM WITH CARBON DISCLOSURE

(71) Applicant: HF investment Ltd., Taichung City (TW)

(72) Inventor: CHIEN-HAO LEE, Taichung City (TW)

(21) Appl. No.: 19/106,731

(22) PCT Filed: Nov. 10, 2022
(86) PCT No.: PCT/CN2022/131015

§ 371 Date: Feb. 26, 2025

(51) Int. Cl. G06Q 30/018; G06K 7/14; G06Q 10/30; G06V 20/52

(52) U.S. Cl. CPC G06Q 30/018; G06Q 10/30; G06V 20/52; G06K 7/1417; G06K 19/06028; G06Q 10/06

(57) ABSTRACT

A metal recycling and regeneration production traceability system with carbon disclosure including a server signal-connected to a warehouse management system, a barcode recognition device, and multiple standard packagings. Each standard packaging includes a label, and each standard packaging is filled with a preset amount of a recycled material. Each standard packaging containing the recycled material is transported to the warehouse management system for storage. The barcode recognition device scans a barcode of each standard packaging to obtain an access node of the server, and carbon emissions at each stage of filling, transporting, and storing the recycled material in the standard packaging are stored in a carbon data report in the server.

### FIELD OF INVENTION

The present invention relates to a metal recycling system, particularly to a metal recycling and regeneration production traceability system with carbon disclosure.

### BACKGROUND OF THE INVENTION

The Oxford Dictionary's 2019 Word of the Year, climate emergency, signifies the growing public recognition of the severe threat posed by global warming and its resulting extreme weather conditions. Human economic activities are the primary contributors to the significant increase in greenhouse gas emissions, which in turn drive the greenhouse effect. As a response, international agreements such as the Paris Agreement and the Kyoto Protocol aim to set timelines for achieving carbon peaking, encouraging industrial production and economic activities within countries to reach carbon neutrality. To achieve the goal of carbon neutrality and mitigate the potential increase in operational costs caused by measures such as the EU's Carbon Border Adjustment Mechanism (CBAM) and other carbon taxes, many companies have already begun efforts to reduce carbon emissions during their production processes.

While many companies express a desire to reduce carbon emissions, most lack sufficient knowledge and direction, often resorting to superficial actions such as recycling materials, planting trees, or installing solar panels. A responsible company committed to reducing carbon emissions must first identify and quantify the carbon emissions across every stage of its production process, known as a “carbon inventory.” Unfortunately, although small and medium-sized enterprises are increasingly aware of the need for carbon inventories, the actual implementation of carbon assessments across supply chain production processes remains poor, not to mention the evaluation of recycled materials and regeneration processes.

### SUMMARY OF THE INVENTION

To address the issues, this present invention discloses a metal recycling and regeneration production traceability system with carbon disclosure comprising a server and the server is signal-connected to a warehouse management system, a barcode recognition device, and multiple standard packagings, wherein: each of the standard packaging comprises a label and is filled with a preset quantity of a recycled material, and the standard packagings are transported to and stored in the warehouse management system; and the barcode recognition device scans a barcode of each standard packaging to obtain an access node of the server and records carbon emission data during each stage of filling, transporting, and storing of the recycled material in the standard packaging, and the carbon emission data are stored in a carbon report within the server.

Wherein, the metal recycling and regeneration production traceability system with carbon disclosure comprises an image capturing device signal-connected to the server, wherein the image capturing device records real-time images of each stage of filling, transporting, and storing of the recycled material in the standard packaging, and the recorded images is stored in the carbon report within the server.

Wherein, for each of the standard packaging filled with the preset quantity of the recycled material, a standard market price is recorded in the carbon report.

Wherein, a sensing device is used to obtain a physical or chemical detection result of the recycled material, determine a purity grade, and generate a grade compensation.

Wherein, the recycled material within the standard packaging is processed through a reprocessing procedure to produce multiple regenerated products, records; the carbon emission data generated during the reprocessing procedure are recorded in the carbon data report, and the carbon emissions are evenly distributed among each of the regenerated products; and a traceability report of the regenerated products is generated.

Wherein, the label is a radio frequency identification label.

Wherein, the label comprises a QR code.

Based on the aforementioned description, the present invention has the following advantages:
1. The present invention comprehensively records the carbon footprint generated during the waste recycling process, systematically producing fair and transparent records in line with ISO principles. This enhances the fairness and reliability of future carbon certificates and fully addresses the issues of existing technologies.
2. The present invention cleverly utilizes monitoring and standard packaging during the recycling and regeneration process, effectively generating production traceability and carbon emission records simultaneously with the output of recycled products. This achieves an intelligent carbon inventory and tracking system with unexpected results.

### BRIEF DESCRIPTION OF THE DRAWINGS

FIG. 1 is a schematic diagram of a preferred embodiment in accordance with the present invention.

### DETAILED DESCRIPTION OF THE PREFERRED EMBODIMENTS

To make it easier for our examiner and people having ordinary skill in the art to understand the technical characteristics of the invention, we use preferred embodiments together with the attached drawings for the detailed description of the invention, in which like reference numerals refer to like parts or operations. It is noteworthy that the embodiments and drawings are used for the purpose of describing and illustrating the technical characteristics of the invention, but not intended to limit the scope of the invention.

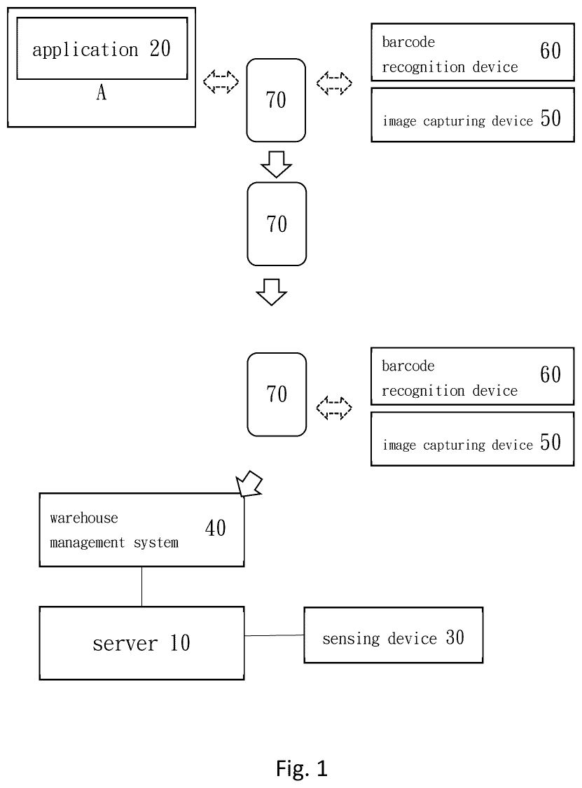

With reference to FIG. 1, a metal recycling and regeneration production traceability system with carbon disclosure is shown. The metal recycling and regeneration production traceability system includes a server 10, one or more applications 20, a sensing device 30, a warehouse management system 40, an image capturing device 50, a barcode recognition device 60, and multiple standard packagings 70. Each of the application 20 is signal-connected to the server 10, enabling signal transmission and communication for interaction and control between the server 10 and each of the application 20. Each of the sensing device 30 is also signal-connected to the server 10, and transmits detection results to the server 10 for recording. The detection results include, but are not limited to, physical or chemical properties such as weight, material, purity, density, metallography, composition, elements, and lattice structure. In other words, the sensing device 30 may include equipment such as weighing scales, elemental analyzers, optical imaging monitors, X-ray diffraction devices, or EDS (Energy Dispersive Spectroscopy) analyzers.

The warehouse management system 40 is signal-connected to the server 10. The warehouse management system 40 includes a storage space for the storage, input, output, total quantity control, and management of materials. The materials can be various types, units, and capacities, each stored in the standard packaging 70. In addition, the warehouse management system 40 also records a greenhouse gas emission history associated with each standard packaging 70 during storage. The greenhouse gas emission may relate to direct greenhouse gas emissions, input energy (air conditioning, lighting, robotic transport, monitoring and management), transportation (forklifts, cranes, company vehicles, trucks, tankers), and other sources. For example, the greenhouse gases generated during the operation of the warehouse management system 40 are allocated to the greenhouse gas emission history of each standard packaging 70. The server 10 retrieves information about the contents of each standard packaging 70 and the associated greenhouse gas emission history from the warehouse management system 40.

Multiple of the image capturing devices 50 and the barcode recognition devices 60 are used to continuously record the entire lifecycle of the standard packaging 70 from production to disposal. The image capturing devices 50 and the barcode recognition devices 60 can be installed at various locations, such as external factories, transport trucks, the storage space, and recycling plants, to document processes involving the production, transportation, storage, and remanufacturing of the standard packaging 70. The image capturing devices 50 and the barcode recognition devices 60 are signal-connected to the server 10. The image capturing devices 50 and the barcode recognition devices 60 acquire digital audio-visual information and recognize a label on each standard packaging 70, generating a recognition result. The recognition result is then transmitted to the server 10. The digital audio-visual information includes, but is not limited to, voice, video, and photographs.

Preferably, during the filling, production, use, and transfer processes of the standard packaging 70, the digital audio-visual information and the recognition results from the image capturing device 50 and the barcode recognition device 60 can be output to the server 10 through the application 20. The application 20 can be installed on a mobile device A, such as one operated by a driver during transportation. The driver can use the built-in image capturing device 50 and the barcode recognition device 60 on the mobile device A to acquire the digital audio-visual information and the recognition results. The recognition results are then updated to the server 10 through the application 20, corresponding to a carbon data report of the standard packaging 70.

### An Embodiment: Recycled Aluminum Chips

One or more of the image capturing devices 50 and the barcode recognition devices 60 are installed on processing equipment in a CNC machine factory. The aluminum chips, with fixed weight and material (such as 7075, 6061 aluminum alloys, etc., 10 kilograms per package), are filled into standard packaging 70. The standard packaging 70 contains a digital label, such as an RFID tag or a QR code. After scanning and recognizing the barcode, the barcode recognition device 60 sends the digital audio-visual information recorded by the image capturing device 50 back to the server 10. This updates the recycling information of the aluminum chips in the factory to the server 10, corresponding to the carbon data report of the standard packaging 70. Therefore, the carbon data report corresponding to each standard packaging 70 starts with the recycled material filled into the standard packaging 70, and continuously monitored through data collection and recording process with digital audio-visual information, ensuring data accuracy and reducing disputes.

A company purchases the standard packaging 70 from the CNC machining factory at a standard market price. A purchase price is recorded in the server 10, corresponding to the carbon data report of the standard packaging 70. The company assigns a transportation vehicle to deliver the standard packaging 70 to the warehouse management system 40 for storage. During transportation, the model of the vehicle, mileage, and fuel consumption are recorded. By scanning the label on the standard packaging 70, the data is output and recorded in the carbon data report corresponding to the standard packaging 70.

Accordingly, when the standard packaging 70 is stored in the warehouse management system 40, monitoring data is updated in the corresponding carbon data report through imaging and scanning. Since the weight and space of the standard packaging 70 are fixed, the carbon emissions from the equipment used during transportation can be calculated and recorded in the carbon data report. Additionally, the storage duration and occupied space in the warehouse are fixed and estimable values. This allows the carbon emissions associated with the aluminum chips inside the standard packaging 70, from generation to transportation and storage, to be accurately and reliably documented in the carbon data report. The carbon data report can also be continuously updated to reflect a carbon emission history of the standard packaging 70 through the combined use of image recording and scanning recognition.

The company retrieves the standard packaging 70 from the warehouse management system 40, conducts a detection of the standard packaging 70 to determine the material purity and composition, assigns a purity grade to the aluminum chips within the standard packaging 70, and records this information in the carbon emission history.

Furthermore, after completing the purity grading, the company may refer to the standard market price at the time of purchase and provide a graded compensation to the CNC factory based on the purity grade of the aluminum chips.

The company processes the aluminum chips from the multiple standard packagings 70 through a reprocessing procedure. During the reprocessing procedure, impurities are removed, required elements are added, and the aluminum chips are melted, decomposed, blended, and refined into an aluminum alloy melt. The aluminum alloy melt is then solidified to form aluminum ingots. Throughout the reprocessing procedure, the carbon emissions directly or indirectly generated by the equipment used are recorded and evenly allocated to the carbon emissions associated with the reprocessing procedure. The records are documented in a carbon data of the aluminum ingot and stored in the server 10. In this manner, the carbon data and production history of each aluminum ingot produced from the recycled aluminum chips can be systematically and effectively recorded in the server 10.

Furthermore, another standard packaging 70 can be utilized, along with the aforementioned recording and scanning methods, to continuously document the emissions generated during the sales process of the aluminum ingot until the aluminum ingot reaches a buyer. These records are stored in the carbon data report corresponding to the standard packaging 70 of the aluminum ingot. As the recording of the aforementioned process is clear, and each step of the procedure is impartially and effectively audited and documented, a carbon certificate corresponding to the aluminum ingot can be directly generated upon shipment.

Based on the above description, this invention discloses a metal recycling and regeneration production traceability system with carbon disclosure that includes:
a server 10 and a warehouse management system 40, a barcode recognition device 60, and multiple standard packagings 70, each of which is signal-connected to the server 10. Each standard packaging 70 includes a label, and each standard packaging 70 is filled with a preset quantity of recycled material. Each standard packaging 70 containing the recycled material is transported to the warehouse management system 40 for storage. The barcode recognition device 60 scans a barcode of each standard packaging 70 to obtain an access node of the server 10, storing the information of the carbon emissions from each stage of filling, transportation, and storage of the recycled material in the standard packaging 70 into a carbon data report on the server 10.

When each standard packaging 70 is filled with the preset quantity of the recycled material, a standard market price is recorded in the carbon data report.

The metal recycling and regeneration production traceability system includes a sensing device 30 to obtain a physical or chemical measurement result of the recycled material, determine a purity grade, and generate a grade-based compensation.

The metal recycling and regeneration production traceability system processes the recycled material within the standard packaging 70 through a reprocessing procedure to produce multiple regenerated products. The carbon emission data from the reprocessing procedure is recorded in the carbon data report and the carbon emissions recorded evenly distributed among each regenerated product, thereby generating a corresponding traceability report that contains production history for each regenerated product.

Wherein the label is a radio frequency identification (RFID) tag.

Based on the aforementioned description, the present invention has the following advantages:
1. The present invention comprehensively records the carbon footprint generated during the waste recycling process, systematically producing fair and transparent records in line with ISO principles. This enhances the fairness and reliability of future carbon certificates and fully addresses the issues of existing technologies.
2. The present invention cleverly utilizes monitoring and standard packaging during the recycling and regeneration process, effectively generating production traceability and carbon emission records simultaneously with the output of recycled products. This achieves an intelligent carbon inventory and tracking system with unexpected results.

While the invention has been described by means of specific embodiments, numerous modifications and variations could be made thereto by those skilled in the art without departing from the scope and spirit of the invention as set forth in the claims.

1. A metal recycling and regeneration production traceability system with carbon disclosure comprising a server and the server is signal-connected to a warehouse management system, a barcode recognition device, and multiple standard packagings, wherein:
each of the standard packaging comprises a label and is filled with a preset quantity of a recycled material, and the standard packagings are transported to and stored in the warehouse management system; and
the barcode recognition device scans a barcode of each standard packaging to obtain an access node of the server and records carbon emission data during each stage of filling, transporting, and storing of the recycled material in the standard packaging, and the carbon emission data are stored in a carbon report within the server.

2. The metal recycling and regeneration production traceability system with carbon disclosure according to claim 1, wherein the metal recycling and regeneration production traceability system with carbon disclosure comprises an image capturing device signal-connected to the server, wherein the image capturing device records real-time images of each stage of filling, transporting, and storing of the recycled material in the standard packaging, and the recorded images is stored in the carbon report within the server.

3. The metal recycling and regeneration production traceability system with carbon disclosure according to claim 2, wherein for each of the standard packaging filled with the preset quantity of the recycled material, a standard market price is recorded in the carbon report.

4. The metal recycling and regeneration production traceability system with carbon disclosure according to claim 2, wherein a sensing device is used to obtain a physical or chemical detection result of the recycled material, determine a purity grade, and generate a grade compensation.

5. The metal recycling and regeneration production traceability system with carbon disclosure according to claim 3, wherein a sensing device is used to obtain a physical or chemical detection result of the recycled material, determine a purity grade, and generate a grade compensation.

6. The metal recycling and regeneration production traceability system with carbon disclosure according to claim 1, wherein:
the recycled material within the standard packaging is processed through a reprocessing procedure to produce multiple regenerated products, records;
the carbon emission data generated during the reprocessing procedure are recorded in the carbon data report, and the carbon emissions are evenly distributed among each of the regenerated products; and
a traceability report of the regenerated products is generated.

7. The metal recycling and regeneration production traceability system with carbon disclosure according to claim 2, wherein:
the recycled material within the standard packaging is processed through a reprocessing procedure to produce multiple regenerated products, records;
the carbon emission data generated during the reprocessing procedure are recorded in the carbon data report, and the carbon emissions are evenly distributed among each of the regenerated products; and
a traceability report of the regenerated products is generated.

8. The metal recycling and regeneration production traceability system with carbon disclosure according to claim 3, wherein:
the recycled material within the standard packaging is processed through a reprocessing procedure to produce multiple regenerated products, records;
the carbon emission data generated during the reprocessing procedure are recorded in the carbon data report, and the carbon emissions are evenly distributed among each of the regenerated products; and
a traceability report of the regenerated products is generated.

9. The metal recycling and regeneration production traceability system with carbon disclosure according to claim 4, wherein:
the recycled material within the standard packaging is processed through a reprocessing procedure to produce multiple regenerated products, records;
the carbon emission data generated during the reprocessing procedure are recorded in the carbon data report, and the carbon emissions are evenly distributed among each of the regenerated products; and
a traceability report of the regenerated products is generated.

10. The metal recycling and regeneration production traceability system with carbon disclosure according to claim 5, wherein:
the recycled material within the standard packaging is processed through a reprocessing procedure to produce multiple regenerated products, records;
the carbon emission data generated during the reprocessing procedure are recorded in the carbon data report, and the carbon emissions are evenly distributed among each of the regenerated products; and
a traceability report of the regenerated products is generated.

11. The metal recycling and regeneration production traceability system with carbon disclosure according to claim 6, wherein the label is a radio frequency identification label.

12. The metal recycling and regeneration production traceability system with carbon disclosure according to claim 7, wherein the label is a radio frequency identification label.

13. The metal recycling and regeneration production traceability system with carbon disclosure according to claim 8, wherein the label is a radio frequency identification label.

14. The metal recycling and regeneration production traceability system with carbon disclosure according to claim 9, wherein the label is a radio frequency identification label.

15. The metal recycling and regeneration production traceability system with carbon disclosure according to claim 10, wherein the label is a radio frequency identification label.

16. The metal recycling and regeneration production traceability system with carbon disclosure according to claim 6, wherein the label comprises a QR code.

17. The metal recycling and regeneration production traceability system with carbon disclosure according to claim 7, wherein the label comprises a QR code.

18. The metal recycling and regeneration production traceability system with carbon disclosure according to claim 8, wherein the label comprises a QR code.

19. The metal recycling and regeneration production traceability system with carbon disclosure according to claim 9, wherein the label comprises a QR code.

20. The metal recycling and regeneration production traceability system with carbon disclosure according to claim 10, wherein the label comprises a QR code.
